(19) United States
(12) Patent Application Publication
(10) Pub. No.: US 2026/0236611 A1
(43) Pub. Date: Aug. 13, 2026

(54) SYSTEM AND METHOD FOR LEGAL CONTRACT ANONYMIZATION AND ENTITY LINKING USING CUSTOM SMALL LANGUAGE MODELS

(71) Applicant: Aracor Inc., Miami, FL (US)

(72) Inventors: Lesly Arun Franco, Chennai (IN); Katya Fisher, Miami, FL (US)

(73) Assignee: Aracor Inc., Miami, FL (US)

(21) Appl. No.: 19/424,044

(22) Filed: Dec. 17, 2025

Related U.S. Application Data
(60) Provisional application No. 63/735,865, filed on Dec. 18, 2024.

(51) Int. Cl. G06F 21/62

(52) U.S. Cl. CPC G06F 21/6254

(57) ABSTRACT

The present invention provides a system and method for anonymizing legal contracts using custom Small Language Models (SLMs). The system identifies and redacts sensitive entities, such as personal information, financial details, and legal clauses, by assigning predefined anonymization tags. If multiple entities in the same category are identified, sequential numbering (e.g., <COMPANY_NAME_1>, <COMPANY_NAME_2>) is applied. The system includes an entity linking module that consolidates related entity variations (e.g., acronyms vs. full names) under a single tag. The process generates a structured mapping of the original entities and their corresponding replacement tags, which can be a JSON object listing the original entities and their corresponding replacement tags, which is used to redact the document. The invention ensures compliance with data privacy regulations such as GDPR and HIPAA, enabling secure document sharing with external LLMs without exposing sensitive information.

### CROSS REFERENCE TO RELATED APPLICATIONS

This application claims the benefit of U.S. Provisional Patent Application No. 63/735,865, filed Dec. 18, 2024, the contents of which are incorporated herein by reference.

### BACKGROUND OF THE INVENTION

The present invention is directed to the field of natural language processing (NLP) and document anonymization. Specifically, it focuses on the anonymization of legal contracts and linking of entities across documents, in some embodiments, using custom Small Language Models (SLMs).

Legal contracts often contain highly sensitive information, including personally identifiable information (PII), protected health information (PHI), confidential financial details, and sensitive legal clauses. Anonymization of this information is essential for secure document sharing and compliance with privacy regulations such as GDPR and HIPAA.

When legal contracts are analyzed by third-party processing systems, for example, submitted to Large Language Models (LLMs) such as OpenAI's ChatGPT, Anthropic's Claude, etc., for analysis, there is a risk that sensitive information could be exposed. Such systems including these models process data externally, which may result in the sensitive data being stored or used for model training. This exposes users to privacy risks, including data breaches or accidental sharing of confidential information.

Organizations require a system that effectively anonymizes legal contracts before external processing, such as processing with LLMs. The anonymization must include legal and financial details along with PII and PHI. Additionally, there must be a way to link related entities to ensure consistent anonymization across the document. By using SLMs, this system can provide efficient, domain-specific processing, allowing organizations to anonymize sensitive information internally while maintaining compliance with privacy regulations such as GDPR.

### SUMMARY OF THE INVENTION

The present invention provides a system and method for anonymizing legal contracts using custom Small Language Models (SLMs). The system identifies and redacts sensitive entities such as personal information, financial details, and legal clauses, assigning predefined anonymization tags. If multiple entities in the same category are identified, sequential numbering (e.g., <COMPANY_NAME_1>, <COMPANY_NAME_2>) is applied. The system includes an entity linking module that consolidates related entity variations (e.g., acronyms vs. full names) under a single tag. The process generates a structured mapping of the original entities and their corresponding replacement tags, which can be a JSON object listing the original entities and their corresponding replacement tags, which is used to redact the document. The invention ensures compliance with data privacy regulations such as GDPR and HIPAA, enabling secure document sharing with external LLMs without exposing sensitive information, and effective processing of this document with encrypted entity names while maintaining the connection between the information disclosed in the original document and the different variations of the same entity.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1A depicts a system architecture diagram, showing the Input Module, Processing Unit, Entity Linking Module, Entity Replacement Module, and Output Module.

FIG. 1B depicts a system architecture diagram, showing the Input Module, SLM Processing Unit, Entity Linking Module, Entity Replacement Module, and Output Module.

FIG. 2A depicts a workflow diagram, showing the steps from document ingestion, sensitive entity identification, mapping generation, entity linking, and final redaction.

FIG. 2B depicts a workflow diagram, showing the steps from document ingestion, sensitive entity identification, JSON generation, entity linking, and final redaction.

FIGS. 3A-B show the entity linking process, demonstrating how variations of the same entity (e.g., “Amazon” and “AWS”) are linked under the same tag.

FIG. 4A is a sample mapping diagram, illustrating how sensitive entities and their anonymized tags are recorded.

FIG. 4B is a sample JSON diagram, illustrating how sensitive entities and their anonymized tags are mapped in JSON format.

### DETAILED DESCRIPTION OF THE PREFERRED EMBODIMENT

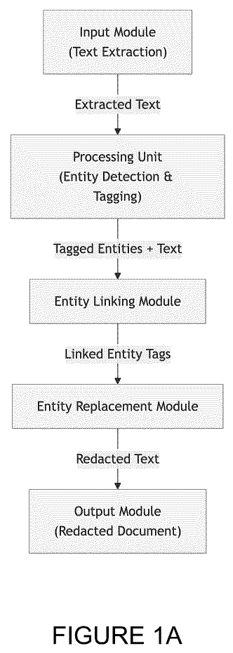

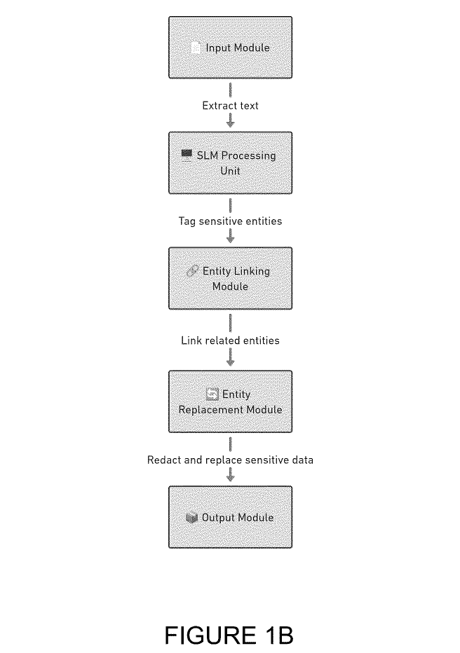

FIGS. 1A-B depict a system architecture diagram, showing the Input Module, Processing Unit (SLM processing unit in FIG. 1B), Entity Linking Module, Entity Replacement Module, and Output Module. In accordance with the preferred embodiment, the invention provides a system for extracting, anonymizing, and linking entities in legal contracts using Small Language Models (SLMs). The system processes legal contracts by detecting sensitive information and replacing it with anonymized tags, ensuring consistency in entity linking. The text extraction module extracts raw text from legal contracts in various formats. The processing unit, which may be an SLM processing unit, as shown in FIG. 1B, identifies sensitive entities and tags them with appropriate anonymization tags (for example, and not by way of limitation, <COMPANY_NAME_1>, <COMPANY_NAME_2>).

The entity linking module links variations of the same entity. For example, and not by way of limitation, the entity linking module would link “Amazon” and “Amazon Web Services” under a single entity tag. The entity replacement module uses the finalized mapping to redact sensitive entities in the contract in order to preserve document structure. The final mapping may be a final JSON. The Output module outputs the redacted document in the original format.

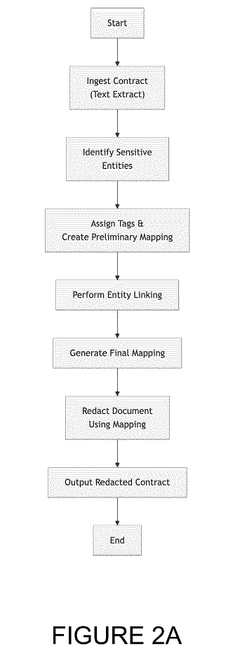

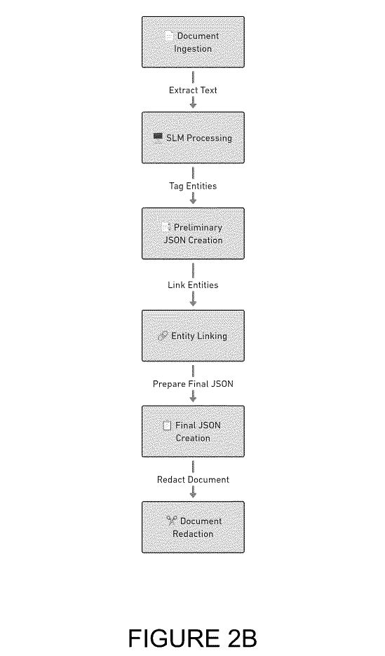

FIGS. 2A-B depict a workflow diagram, showing the steps from document ingestion, sensitive entity identification, mapping generation (which may be JSON generation as shown in FIG. 2B), entity linking, and final redaction. In accordance with the preferred embodiment of the present invention, legal contracts are ingested and parsed into processable formats. This may be referred to as “text extraction.” During processing, which may be SLM processing, sensitive entities are identified and tagged. A JSON object or other mapping means lists the original entities and their tags during a preliminary mapping generation. Variations of the same entity are linked to ensure consistent anonymization during the entity linking stage. The final mapping is prepared with all entities linked and tagged, and the document is redacted using the final mapping, replacing all sensitive entities. By anonymizing the contract before sharing it with external third-party processing systems, including LLMs, the invention ensures compliance with privacy regulations like GDPR, preventing the exposure of sensitive data.

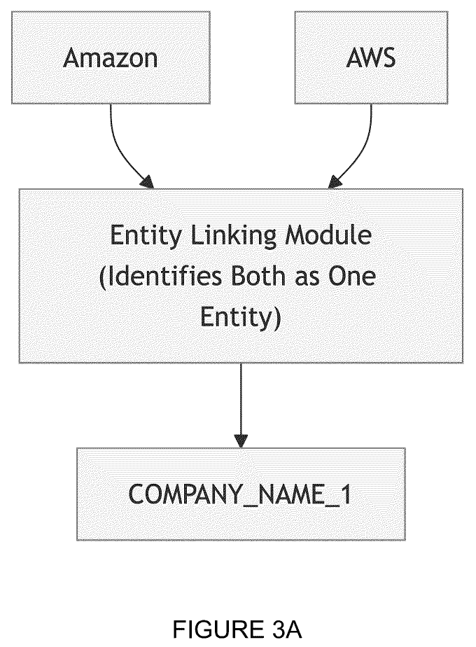

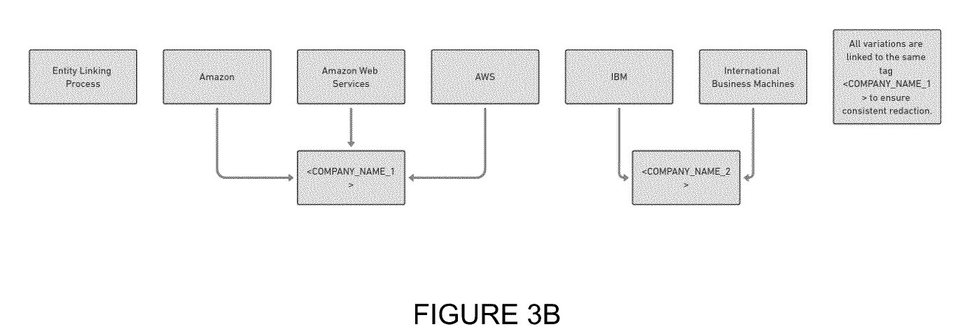

FIG. 3A-B show the entity linking process, demonstrating how variations of the same entity are linked under the same tag. The Entity Linking Module consolidates related entity variations (e.g., acronyms vs. full names) under a single tag. The Entity Linking Module can identify more than one variation of the same entity as being such a variation and can thus identify and label all such variations as one entity. For example, and not by way of limitation, “Amazon,” “AWS,” and “Amazon Web Services” can be identified as variations of the same entity and can be given the same anonymization tag such as <COMPANY_NAME_1>. Similarly, for example, and not by way of limitation, “IBM” and “International Business Machines” can be identified as variations of the same entity and can be given the same anonymization tag such as <COMPANY_NAME_2>. All variations of one entity are linked to the same tag (for example, and not by way of limitation, <COMPANY_NAME_1>, <COMPANY_NAME_2>) to ensure consistent redaction.

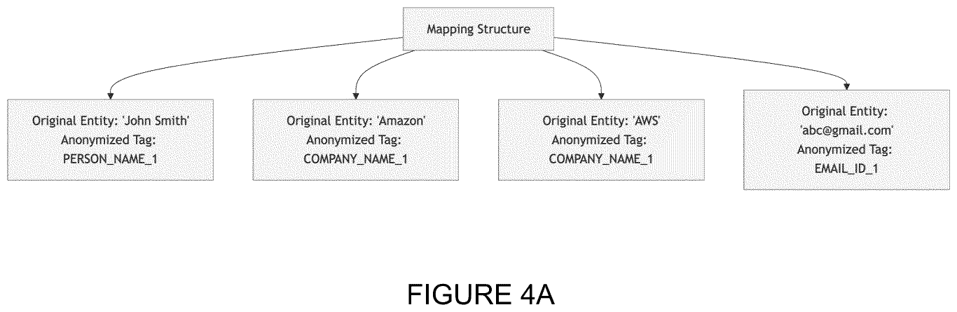

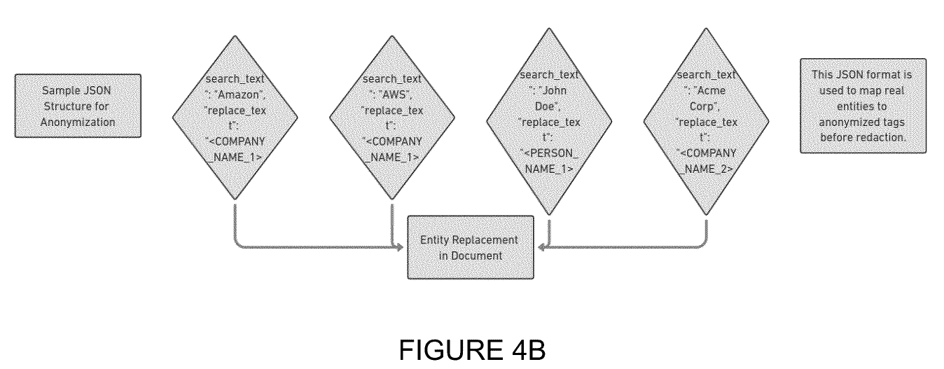

FIG. 4A is a sample mapping diagram, illustrating how sensitive entities and their anonymized tags are recorded. Original entities including, and not by way of limitation, names of people, names of companies, and emails can be anonymized. For example, and not by way of limitation, the original entity ‘John Smith’ can be anonymized to the tag <PERSON_NAME_1>. For example, and not by way of limitation, the original entity ‘Amazon’ can be anonymized to the tag <COMPANY_NAME_1>, and the original entity ‘AWS’ can also be anonymized to the tag <COMPANY_NAME_1>due to the entity linking process. For example, and not by way of limitation, the original entity ‘abc@gmail.com’ can be anonymized to the tag <EMAIL_ID_1>.

FIG. 4B is a sample JSON diagram, illustrating how sensitive entities and their anonymized tags are mapped in JSON format. The JSON structure for anonymization allows for entity replacement in the document. The JSON format may be used to map real entities to anonymized tags before redaction. For example, and not by way of limitation, the JSON format can be used to search for the text of the original entity ‘Amazon’ and then can be used to replace the text with the anonymized tag <COMPANY_NAME_1>, and the original entity ‘AWS’ can also be anonymized to the tag <COMPANY_NAME_1>due to the entity linking process. For example, and not by way of limitation, the JSON format can be used to search for the text of the original entity ‘John Doe’ and then can be used to replace the text with the anonymized tag <PERSON_NAME_1>. For example, and not by way of limitation, the JSON format can be used to search for the text of the original entity ‘Acme Corp’ and then can be used to replace the text with the anonymized tag <COMPANY_NAME_2>.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for legal contract anonymization, comprising:
an input module for extracting raw text from legal contracts;
a small language model (SLM) processing unit for identifying sensitive entities, tagging said sensitive entities, and generating a JSON object;
an entity linking module for consolidating variations of the same entity;
an entity replacement module for redacting the contract using the final JSON object; and
an output module for exporting the redacted contract.

2. The system of claim 1, wherein said input module supports various document formats.

3. The system of claim 1, wherein said SLM is trained on legal texts for enhanced accuracy.

4. The system of claim 1, wherein said anonymization complies with GDPR and HIPAA.

5. The system of claim 1, wherein the system creates an individual tag for each entity and links it to all variations of the names of the particular entity.

6. A system for legal contract anonymization, comprising:
an input module for extracting raw text from legal contracts;
a processing unit for identifying sensitive entities, tagging them, and generating a data mapping;
an entity linking module for consolidating variations of the same entity;
an entity replacement module for redacting the contract using the final mapping; and
an output module for exporting the redacted contract.

7. The system of claim 5, wherein the input module supports various document formats.

8. The system of claim 5, wherein the processing unit is trained on legal texts for enhanced accuracy.

9. The system of claim 5, wherein anonymization complies with GDPR and HIPAA.

10. The system of claim 5, wherein the system creates an individual tag for each entity and links it to all variations of the names of the particular entity.

11. A method for anonymizing legal contracts, comprising:
extracting text from legal contracts;
using a small language model (SLM) to identify and tag sensitive entities;
generating a JSON object listing entity-tag mappings;
performing entity linking to unify variations of the same entity;
using a final JSON to redact the document; and
outputting said redacted document.

12. The method of claim 11, wherein said entity linking detects variations in entity names.

13. A method for anonymizing legal contracts, comprising:
extracting text from legal contracts;
identifying and tagging sensitive entities;
generating a mapping of entity-tag correspondences;
performing entity linking to unify variations of the same entity;
using the final mapping to redact the document; and
outputting the redacted contract.

14. The method of claim 13, wherein entity linking detects variations in entity names.
